(19) United States
(12) Patent Application Publication
(10) Pub. No.: US 2012/0204603 A1
(43) Pub. Date: Aug. 16, 2012

(54) METHOD FOR PRODUCING GLASS SUBSTRATE FOR MAGNETIC RECORDING MEDIUM

(75) Inventor: Kazuyuki HANEDA, Ichihara-shi (JP)

(73) Assignee: SHOWA DENKO K.K., Tokyo (JP)

(21) Appl. No.: 13/372,847

(22) Filed: Feb. 14, 2012

(30) Foreign Application Priority Data
Feb. 16, 2011 (JP) 2011-030986

(51) Int. Cl. C03C 15/00; B24B 1/00; C03C 19/00

(52) U.S. Cl. 65/31; 451/41

(57) ABSTRACT

The object of the present invention is to provide a production method for a glass substrate having a sufficient impact resistance for a magnetic recording medium with high productivity, without using cerium oxide, or by decreasing the amount of cerium oxide used in the polishing step, and the present invention provides a method for producing a glass substrate for a magnetic recording medium including at least a grinding step for inner and outer peripheries of a disc-shaped glass substrate having a center hole, wherein the grinding step includes a first grinding step for inner and outer peripheries of the glass substrate using a metal-bonded diamond grinding stone in which diamond abrasive grains are fixed with a metal binder, and a second grinding step for the inner and outer peripheries of the glass substrate using a resin-bonded diamond grinding stone in which diamond abrasive grains are fixed with a resin binder.

### CROSS-REFERENCE TO RELATED APPLICATIONS

This application is based on Japanese Patent Application No. 2011-030986 filed in Japan on Feb. 16, 2011, the content of which is incorporated herein by reference.

### TECHNICAL FIELD

The present invention relates to a method for producing a glass substrate for a magnetic recording medium.

### BACKGROUND ART

The recording density of magnetic recording media used for hard disc drives (HDD) has greatly improved. In particular, since the introduction of a MR head or PRML technique, the in-plane recording density requires further improvement. In recent years, due to the introduction of GMR and TMR heads, the in-plane recording density has increased at a rate of about 1.5 times a year. However, a further increase of the in-plane recording density is required.

Along with an improvement of the recording density of magnetic recording media, demands for a substrate for a magnetic recording medium are also increasing. As a substrate for a magnetic recording medium, an aluminum alloy substrate or a glass substrate has been used. In general, a glass substrate is superior to an aluminum alloy substrate in terms of hardness, surface smoothness, stiffness, and impact resistance. Therefore, a glass substrate for a magnetic recording medium which can achieve a high recording density has received increasing attention.

When a glass substrate for a magnetic recording medium is produced, a disc-shaped glass substrate is cut out from a large glass plate or directly press-molded melt glass using a mold, and then the main surfaces and the peripheries of the obtained glass substrate are subjected to a lapping process (grinding process) and a polishing process.

In a conventional production process for a glass substrate for a magnetic recording medium, the main surfaces of the glass substrate are subjected to a first lapping (grinding) process, a second lapping (grinding) process, a first polishing process, and a second polishing process. In addition, a grinding process and a polishing process for the inner and outer peripheries of the glass substrate are carried out between these processes.

Moreover, Japanese Unexamined Patent Application, First Publication No. 2010-30807 discloses a production method for a glass substrate including a grinding process for inner and outer peripheries using a grinding stone, a chamfering process for inner and outer edges, and a polishing process for the inner and outer peripheries using a slurry (loose abrasive) containing cerium oxide as a grinding stone.

Japanese Unexamined Patent Application, First Publication No. 2010-003365 discloses a production method for a glass substrate for a magnetic disc including a grinding process for the inner and outer peripheries of a donut-shaped glass block, an etching process for the inner and outer peripheries of the grinded donut-shaped glass block, a separating process for the etched donut-shaped glass block into several donut-shaped glass plates, a cleaning process for the donut-shaped glass substrates, a chamfering process for the edges of the inner and outer peripheries of the cleaned donut-shaped glass plates, and a polishing process for the edges of the inner and outer peripheries and chamfered portions of the chamfered donut-shaped glass substrates, in this order.

On the other hand, in order to further improve high recording density of the HDD, it is necessary to increase the number of magnetic recording media arranged in a limited space in the HDD. As one solution, a glass substrate for a magnetic recording medium thinner can be conceived. In this case, a glass substrate for a magnetic recording medium is required to have impact strength which is equivalent or larger than that of a conventional glass substrate for a magnetic recording medium.

Therefore, in order to prevent cracking that may occur in the inner and outer peripheries and the chamfered faces in the glass plate, which is one factor for decreasing the impact strength of the glass substrate, a chemical-mechanical polishing (CMP) using cerium oxide is generally carried out as an essential process.

However, cerium oxide, which is essential in the polishing process for a glass substrate for a magnetic recording medium, is becoming difficult to obtain in recent years. Therefore, a production method for a glass substrate for a magnetic recording medium having impact strength, which is equivalent or larger than that of a conventional glass substrate, without using cerium oxide, or by decreasing the amount of cerium oxide used in the polishing process, is required. In addition, production of a glass substrate for a magnetic recording medium with high productivity is also required.

The present invention has been accomplished in view of the foregoing, and an object of the present invention is to provide a method for producing a glass substrate for a magnetic recording medium having sufficient impact strength without using cerium oxide, or by decreasing the amount of cerium oxide used in the polishing process, and which can produce a glass substrate for a magnetic recording medium with high productivity.

Given the above, the present invention provides the following solutions.
(1) A method for producing a glass substrate for a magnetic recording medium including at least a grinding step for inner and outer peripheries of a disc-shaped glass substrate having a center hole,

wherein the grinding step includes a first grinding step for inner and outer peripheries of the glass substrate using a metal bonded diamond grinding stone in which diamond abrasive grains are fixed with a metal binder, and a second grinding step for the inner and outer peripheries of the glass substrate using a resin-bonded diamond grinding stone in which diamond abrasive grains are fixed with a resin binder.
(2) The method for producing a glass substrate for a magnetic recording medium according to (1), wherein the method further includes an etching step for the inner and outer peripheries of the glass substrate.
(3) The method for producing a glass substrate for a magnetic recording medium according to (1) or (2), wherein the etching step is carried out after the first or second grinding step.
(4) The method for producing a glass substrate for a magnetic recording medium according to any one of (1) to (3), wherein the method further includes a polishing step for the inner and outer peripheries of the glass substrate.
(5) The method for producing a glass substrate for a magnetic recording medium according to (4), wherein the polishing step is carried out after the second grinding step.
(6) The method for producing a glass substrate for a magnetic recording medium according to (4) or (5), wherein the polishing step is carried out without cerium oxide as an abrasive.
(7) The method for producing a glass substrate for a magnetic recording medium according to any one of (1) to (6), wherein an average grain diameter of the diamond abrasive grains in the metal bonded diamond grinding stone is in a range from 10 μm to 60 μm, and an average grain diameter of the diamond abrasive grains in the resin-bonded diamond grinding stone is in a range from 2 μm to 20 μm.
(8) The method for producing a glass substrate for a magnetic recording medium according to any one of (1) to (7), wherein the binder in the metal bonded diamond grinding stone is nickel or a nickel alloy, and the binder in the resin-bonded diamond grinding stone is a phenol resin.

According to the present invention, it is possible to produce a glass substrate having sufficient impact resistance for a magnetic recording medium with high productivity, without using cerium oxide, or by decreasing the amount of cerium oxide used in the polishing process.

### BRIEF DESCRIPTION OF THE DRAWINGS

FIG. 1 is a perspective view explaining the production method for a glass substrate for a magnetic recording medium according to the present invention, specifically showing a lapping step for main surfaces.

FIG. 2A is an enlarged planar view showing a pad surface of a diamond pad used in the lapping step for the main surfaces.

FIG. 2B is an enlarged cross-sectional view showing the diamond pad when the diamond pad shown in FIG. 2A is cut along the A-A′ line.

FIG. 3 is a perspective view explaining the production method for a glass substrate for a magnetic recording medium according to the present invention, specifically for showing first and second grinding steps for inner and outer peripheries.

FIG. 4 is perspective view explaining the production method for a glass substrate for a magnetic recording medium according to the present invention, specifically for showing a polishing step for an inner periphery.

FIG. 5 is perspective view explaining the production method for a glass substrate for a magnetic recording medium according to the present invention, specifically for showing a polishing step for an outer periphery.

FIG. 6 is perspective view explaining the production method for a glass substrate for a magnetic recording medium according to the present invention, specifically for showing a polishing step for main surfaces.

FIG. 7 is perspective view showing another lapping machine or polishing machine used in the present invention.

### MODES FOR CARRYING OUT THE INVENTION

Below, the embodiments of a method for producing a glass substrate for a magnetic recording medium according to the present invention will be explained referring to figures.

The glass substrate for a magnetic recording medium obtained by the production method according to the present invention is a disc-shaped glass substrate having a center hole. The magnetic recording medium includes a glass substrate, a magnetic layer, a protective layer, a lubricant layer, etc. which are laminated on the glass substrate in this order. In the magnetic recording and reproducing device (HDD), the center portion of the magnetic recording medium is fixed to a rotation axis of a spindle motor. Recording to or reading of the magnetic recording medium is carried out while a magnetic head is floating on the main surface of the magnetic recording medium rotating by the spindle motor.

Examples of the glass substrate for a magnetic recording medium include SiO₂—Al₂O₃—R₂O-based (R means at least one of selected from the group of alkali metal elements) chemically-strengthened glass, SiO₂—Al₂O₃—Li₂O-based glass ceramics, and SiO₂—Al₂O₃—MgO—Ti₂O-based glass ceramics. Among these, SiO₂—Al₂O₃—MgO—CaO—Li₂O—Na₂O—ZrO₂—Y₂O₃—Ti₂O—As₂O₃-based chemically-strengthened glass, SiO₂—Al₂O₃—Li₂O—Na₂O—ZrO₂—As₂O₃-based chemically-strengthened glass, SiO₂—Al₂O₃—MgO—ZnO—Li₂O—P₂O₅—ZrO₂₋K₂O—Sb₂O₃-based glass ceramics, SiO₂—Al₂O₃—MgO—CaO—BaO—TiO₂—P ₂O₅—As₂O₃-based glass ceramics and SiO₂—Al₂O₃—MgO—CaO—SrO—BaO—TiO₂—ZrO₂—Bi₂O₃—Sb₂O₃-based glass ceramics are preferably used. In addition, lithium disilicate, SiO₂-based crystals (such as quartz, cristobalite, and tridymite), cordierite, enstatite, aluminum magnesium titanate, spinel crystals (such as [Mg and/or Zn]Al₂O₄, [Mg and/or Zn]TiO₄, and a solid solution of these crystals), forsterite, spodumene, and glass ceramics containing a solid solution of these crystals as a crystal phase are also preferably used.

When the glass substrate for a magnetic recording medium is produced, first, a disc-shaped glass substrate having a center hole is made by cutting out from a large glass plate or directly press-molding melted glass using a mold.

Then, the surfaces (main surfaces) except for the peripheries of the obtained glass substrate are subjected to a lapping step (grinding step) and a polishing step (polishing process). Preferably at least a grinding step, and more preferably an etching step and a polishing step for the inner and outer peripheries of the glass substrate, is carried out between the lapping step and the polishing step on the main surfaces. In the present invention, the grinding step for the inner and outer peripheries of the glass substrate is carried out in two steps (a first grinding step and a second grinding step). Moreover, it is also possible to carry out a chamfering step on the inner and outer peripheries of the glass substrate at the same time as the grinding step.

The production method according to the present invention includes a grinding step (a first grinding step) for both the inner and outer peripheries of the glass substrate using a diamond grinding stone for the inner and outer peripheries. If microcracks are generated in this step they are removed by the subsequent grinding step (a second grinding step) or an etching step. Thereby it is possible to produce a glass substrate for a magnetic recording medium having impact strength equivalent to that of a conventional glass substrate without a final polishing step, which has been carried out on the inner and outer peripheries of the glass substrate, or with a simplified final polishing step.

Thus, a chemical mechanical polishing (CMP) using a cerium oxide slurry is carried out in a polishing step for the inner and outer peripheries of the glass substrate in a conventional production method for a glass substrate for a magnetic recording medium. When the polishing step for the inner and outer peripheries using a cerium oxide slurry is replaced with a silicon oxide slurry, or the polishing step is not carried out, polishing effects due to CMP are insufficient.

In the present invention, microcracks generated in the inner and outer peripheries of the glass substrate can be removed by replacing the chemical polishing with etching. In addition, it is also possible to remove microcracks generated in the first grinding step by using a resin-bonded diamond grinding stone, in which diamond abrasive grains are fixed with a resin binder, in the second grinding step. Furthermore, it is also possible to prevent the generation of new microcracks by using the resin-bonded diamond grinding stone in the second grinding step.

Therefore, it is possible to process the inner and outer peripheries of the glass substrate without using an expensive cerium oxide slurry used in a conventional polishing step, or to decrease the amount of the cerium oxide slurry used.

In addition, a cerium oxide slurry used in a polishing step in a conventional method is not necessary in the polishing step for the inner and outer peripheries of the glass substrate in the present invention. The production method according to the present invention only includes a polishing step using a silicon oxide slurry. As such, it is possible to reduce the time for polishing using a cerium oxide slurry and thereby the amount of cerium oxide slurry used can be decreased. Therefore, the present invention can reduce the polishing cost of a glass substrate for a magnetic recording medium, and achieve high productivity.

Below, the production method for a glass substrate for a magnetic recording medium according to the present invention will be explained in detail referring to embodiments.

In this embodiment, a first lapping step for main surfaces, a first grinding step for inner and outer peripheries, a second grinding step for the inner and outer peripheries, an etching step for the inner and outer peripheries, a polishing step for the inner periphery, a second lapping step for the main surfaces, a third lapping step for the main surfaces, a polishing step for the outer periphery, and a polishing step for the main surfaces are carried out.

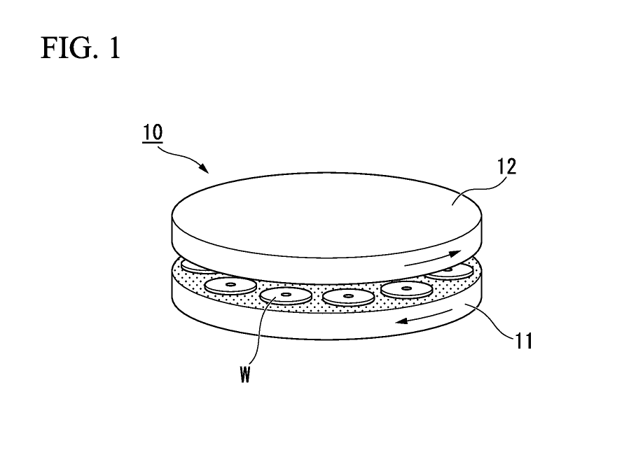

In the first lapping step for main surfaces, both main surfaces (the surfaces which finally become recording surfaces) of the glass substrate W are lapped using a lapping machine 10 shown in FIG. 1. Specifically, the lapping machine 10 includes a pair of lapping plates 11 and 12 which are vertically arranged and rotate in the opposite direction to each other. Plural glass substrates W are interposed between the lapping plates 11 and 12. At the same time, the main surfaces of the glass substrates W are grinded by a grinding pad mounted on the lapping plates 11 and 12.

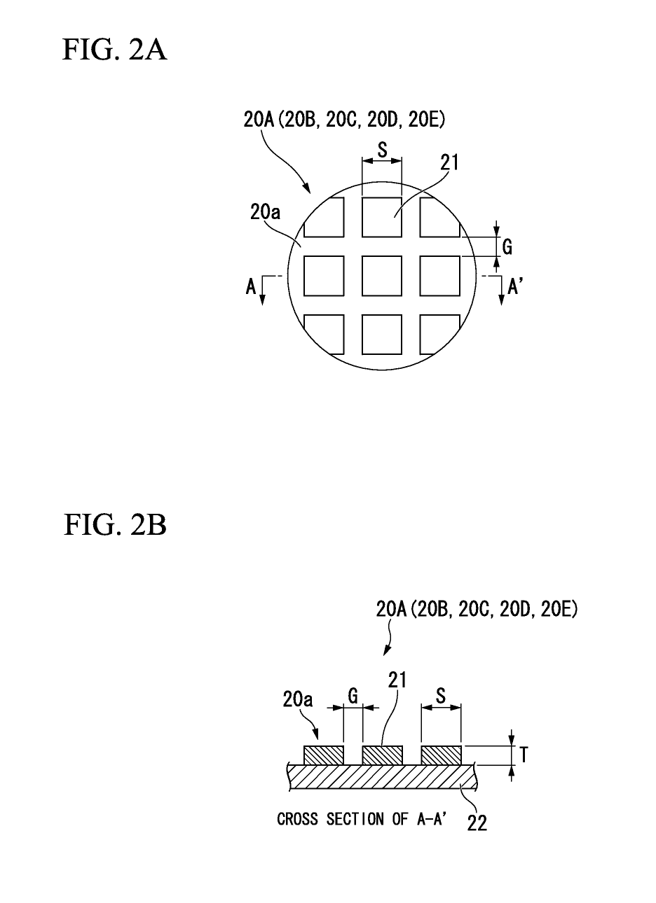

The grinding pad used in the first lapping step is a diamond pad 20A shown in FIGS. 2A and 2B. The diamond pad 20A has a substrate 22 having a lap surface 20a. On the lap surface 20a, plural protrusions 21 are disposed having a flat top in which diamond abrasive grains are fixed with a binder (bond).

In the diamond pad 20A used in the first lapping step, the outside dimension S of the protrusion 21 preferably has a size of 1.5 mm to 5 mm square, 0.2 mm to 3 mm in height T, and 0.5 mm to 3 mm in gap G between adjacent protrusions 21. A cooling solution or a grinding fluid reaches uniformly all parts of the diamond pad 20A having such dimensions. It is also possible to remove grinding shavings, etc. from the gaps between the protrusions 21 on the lap surface 20a in the diamond pad 20A.

In the diamond pad 20A used in the first lapping step, an average grain diameter of the diamond abrasive grains is preferably in a range of 4 μm to 12 μm. The content of the diamond abrasive grains in the protrusions 21 is preferably in a range of 5% by volume to 70% by volume, and more preferably in a range of 20% by volume to 30% by volume. When the grain diameter or the content of the diamond abrasive grains is less than the lower limit, the process time is longer, thus increasing the process cost. On the other hand, when the grain diameter or the content of the diamond abrasive grains is more than the upper limit, it becomes difficult to obtain a desired surface roughness. Moreover, as the binder of the diamond pad 20A, polyurethane resins, phenol resins, melamine resins or acrylic resins can be used.

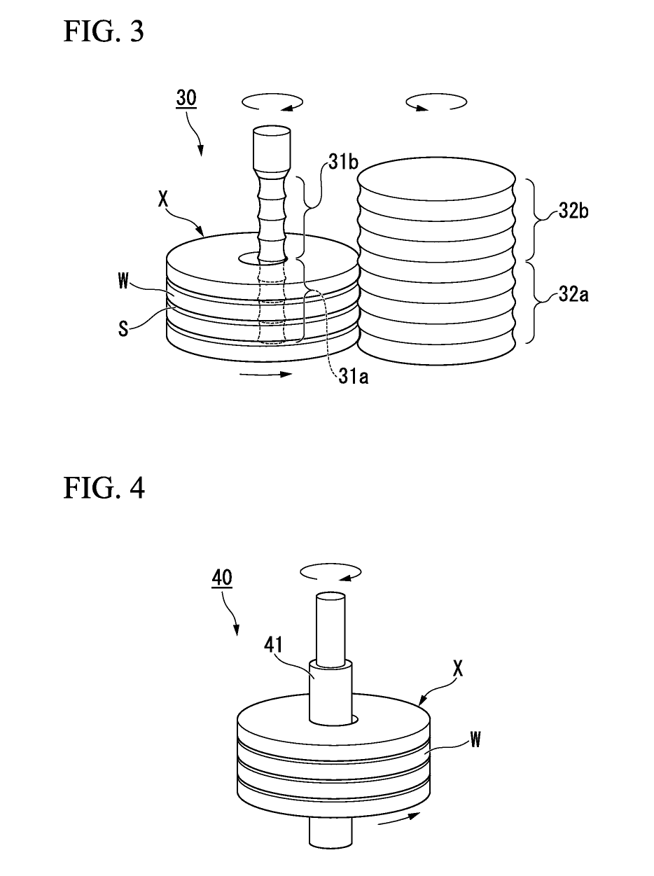

In the first grinding step for the inner and outer peripheries, the inner periphery, which is the side wall of the center hole, and the outer periphery of the glass substrate W are grinded using the grinding machine 30 shown in FIG. 3. Specifically, the grinding machine 30 has a first inner grinding stone 31a and a first outer grinding stone 32a. A laminated body X, which was obtained by laminating plural glass substrates W and inserting a spacer S between the glass substrates W so as to align the center holes of the glass substrates W and the spacer S, is rotated around the axis of the first inner grinding stone 31a. At the same time, the laminated body X is interposed in the radial direction between the first inner grinding stone 31a, which is inserted into the center hole of the laminated body X, and the first outer grinding stone 32a, which is arranged at the outer circumference of the laminated body X. Then, the first inner grinding stone 31a and the outer grinding stone 32a rotate in an opposite direction of the rotation direction of the laminated body X. Thereby, the inner periphery of the glass substrates W is grinded by the first inner grinding stone 31a. At the same time, the outer periphery of the glass substrates W is also grinded by the first outer grinding stone 32a.

The surface of the first inner grinding stone 31a and the first outer grinding stone 32a has a corrugated shape in which a recess and a protrusion are alternatively arranged in the longitudinal direction. Therefore, it is possible to chamfer the edge portions between the main surfaces and the inner periphery and the edge portions between the main surfaces and the outer periphery, whilst grinding the inner and peripheries of the glass substrates W.

As the first inner grinding stone 31a and the first outer grinding stone 32a, a metal bonded diamond grinding stone, in which the diamond abrasive grains are fixed with a metal binder, is used. Examples of the metal binder include copper, copper alloys, nickel, nickel alloys, cobalt, and tungsten carbide. Among these metal binders, nickel and nickel alloys are preferably used.

The average grain diameter of the diamond abrasive grains contained in the first inner and outer grinding stones 31a and 32a is preferably in a range of 10 μm to 60 μm. The first inner and outer grinding stones 31a and 32a preferably contain the diamond abrasive grains in a range of 30% by volume to 95% by volume, and more preferably in a range of 50% by volume to 85% by volume. When the average grain diameter or the content of the diamond abrasive grains is lower than the lower limit, the processing time is longer, and increases the process cost. On the other hand, when it exceeds the upper limit, it is difficult to obtain a desired surface roughness.

In the subsequent second grinding step for the inner and outer peripheries, the inner periphery, which is the side wall of the center hole, and the outer periphery of the glass substrate W are secondarily grinded using the grinding machine 30 shown in FIG. 3. Specifically, the grinding machine 30 has second inner and outer grinding stones 31b and 32b, which are continuously arranged in the axial direction to the first inner and outer grinding stones 31a and 32a. A laminated body X, which was obtained by laminating plural glass substrates W and inserting a spacer S between the glass substrates W so as to align the center holes of the glass substrates and the spacers S, is rotated around the axis of the second inner grinding stones 31b. At the same time, the laminated body X is interposed in the radial direction between the second inner grinding stone 31b, which is inserted into the center hole of the laminated body X, and the second outer grinding stone 32b, which is arranged at the outer circumference of the laminated body X. Then, the second inner and outer grinding stones 31b and 32b rotate in an opposite direction of the rotation direction of the laminated body X. Thereby, the inner periphery of the glass substrates W is grinded by the second inner grinding stone 31b. At the same time, the outer periphery of the glass substrates W is also grinded by the second outer grinding stone 32b. In addition, the edge portions between the main surfaces and the inner periphery and the edge portions between the main surfaces and the outer periphery are chamfered.

That is, the first grinding step and the second grinding step for the inner and outer peripheries can be continuously carried out by changing the position of the first inner and outer grinding stones 31a and 32a and the second inner and outer grinding stones 31b and 32b relative to the inner and outer peripheries of the glass substrate W.

As the second inner and outer grinding stones 31b and 32b, a resin-bonded diamond grinding stone, in which the diamond abrasive grains are fixed with a resin binder, is used. Examples of the resin binder include phenol resins, phenol aralkyl resins, polyimide resins, acetal resins, elastic rubbers. Among these resin binders, phenol resins are preferably used.

The average grain diameter of the diamond abrasive grains contained in the second inner and outer grinding stones 31b and 32b is preferably in a range of 2 μm to 20 μm, and the average grain diameter of the diamond abrasive grains contained in the second inner and outer grinding stone 31b and 32b is preferably smaller than that of the diamond abrasive grains contained in the first inner and outer grinding stone 31a and 32a respectively. The second inner and outer grinding stones 31b and 32b preferably contain the diamond abrasive grains in a range of 30% by volume to 95% by volume, and more preferably in a range of 50% by volume to 85% by volume. When the average grain diameter or the content of the diamond abrasive grains is lower than the lower limit, the process time is longer, and increases the process cost. On the other hand, when it exceeds the upper limit, it is difficult to obtain a desired surface roughness.

After the second grinding step for the inner and outer peripheries, an etching step for the inner and outer peripheries is carried out. This etching step for the inner and outer peripheries is not shown in figures.

In the etching step for the inner and outer peripheries, the laminated body X including the glass substrates W having chamfers, which are formed in the previous first and second grinding steps for the inner and outer peripheries, is immersed in an etchant in an etchant tank, and the inner and outer peripheries of the glass substrates W are etched. This etching step compensates the chemical polishing functions in a conventional CMP using a cerium slurry, and removes microcracks generated in the inner and outer peripheries of the glass substrates W. Moreover, when the chamfer is made before etching similar to this embodiment, it is possible to remove microcracks not only in the inner and outer peripheries but also microcracks in the chamfer.

In the etching step, the etchant immerses into the microcracks generated in the glass substrates W in the first and second grinding step for the inner and outer peripheries, the bottom of the microcracks is etched, and the microcracks have a round bottom. Thereby, when stress is applied to the round bottom, cracking does not progress any more. On the other hand, the shallow microcracks are removed in this etching step. As a result, the glass substrate W, from which microcracks are removed, has improved mechanical strength (impact resistance). The magnetic recording medium including this glass substrate W has also improved impact resistance.

In addition, the inner and outer peripheries of the glass substrate W having chamfers which are formed in the grinding step for the inner and outer peripheries can be also etched by immersing the glass substrates W in the etchant in the etchant tank.

As explained above, the etching step can be carried out by immersing the glass substrates W into the etchant. However, the etching step in the present invention is not limited to this embodiment. The etching step can also be carried out by coating the etchant to the inner and outer peripheries of the glass substrate W in the present invention.

Any etchant can be used as long as it has etching functions to the glass substrate W. Examples of the etchant include hydrofluoric acid-based etchant mainly containing hydrofluoric acid (HF), or hydrofluosilicic acid (H₂SiF₆). Among these hydrofluoric acid-based etchants, a hydrofluoric acid solution is preferably used. In addition, it is also possible to adjust the intensity or characteristic of etching by adding an inorganic acid, such as sulfuric acid, nitric acid, and hydrochloric acid into the hydrofluoric acid-based etchant. The hydrofluoric acid-based etchant has any concentration as along as it can remove the microcracks in the surface of the glass substrate W without roughening the surface after the grinding step for the inner and outer peripheries. However, the concentration of the hydrofluoric acid-based etchant is preferably in a range of 0.01% by mass to 10% by mass.

The immersion conditions of the glass substrate W vary depending on the kinds or concentration of the etchant used or the material of the glass substrate W. However, it is preferable that the temperature of the etchant be in a range of 15° C. to 65° C., the etching time (immersion time) be in a range of 0.5 min to 30 min. Specifically, the glass substrate W is immersed into a hydrofluoric acid aqueous solution with a concentration of 0.5% by mass at 30° C. for about 15 min or a mixture containing hydrofluoric acid with a concentration of 1.5% by mass and sulfuric acid with a concentration of 0.5% by mass at 30° C. for about 10 min. Moreover, in the etching step for the inner and outer peripheries, the entire surface of the glass substrate W may be etched, or the glass substrate W may also be partially etched. That is, only the inner and outer peripheries of the glass substrate W may be etched. Furthermore, after this etching step, it is preferable to clean the glass substrate W to remove the etchant attached to the glass substrate W.

In the subsequent polishing step for the inner periphery, the side wall of the center hole, that is, the inner periphery of the glass substrate W is polished by using the polishing machine shown in FIG. 4. The polishing machine 40 has a polishing brush 41 for the inner periphery. In the polishing step, the laminated body X rotates around the axis of the polishing brush 41. At the same time, the polishing brush 41, which is inserted into the center hole of the glass substrates W, vertically moves while rotating in the opposite direction to the rotation direction of the glass substrates W. During this time, a polishing liquid is dropped to the polishing brush 41 for the inner periphery. Thereby, the inner periphery of the glass substrates W is polished by the polishing brush 41 for the inner periphery. At the same time, the edge portions (chamfer) in the inner periphery of the glass substrates W, which are chamfered in the grinding step for the inner and outer peripheries, are also polished. Moreover, as the polishing liquid, a slurry, which is obtained by dispersing silicon oxide (colloidal silica) abrasive grains or cerium oxide abrasive grains in water, can be used.

Moreover, by its very nature, it is difficult to shorten the time for the polishing step. Therefore, the polishing step needs a process time which is longer than the process time in the grinding step. On the other hand, the smoothness of the inner periphery (including the chamfers) of the glass substrate is lower than that (Ra: 0.3 nm to 0.5 nm) of the main surfaces, specifically, the Ry of the inner periphery is 10 μm or less (several micrometers). Therefore, when silicon oxide (colloidal silica) abrasive grains (grain diameter: 0.3 μm or less) are used, since the silicon oxide is too fine, the process time in polishing generally tends to be longer. Due to this fact, the average grain diameter of the silicon oxide (colloidal silica) abrasive grains is preferably in a range of 0.4 μm to 1 μm, and more preferably in a range of 0.45 μm to 0.6 μm.

In addition, since the inner periphery of the glass substrate W can be etched in the present invention, the microcracks in the inner periphery can also be removed. Therefore, when the glass substrate W is polished with a cerium oxide slurry, the process time can be reduced.

In the subsequent second lapping step for the main surfaces, the main surfaces of the glass substrate W are lapped secondarily by using the lapping machine 10 shown in FIG. 1. The lapping machine has a pair of the lapping plates 11 and 12 which are vertically arranged and rotate in opposite directions to each other. The main surfaces of the glass substrate W are grinded by the grinding pad attached to the lapping plates 11 and 12 while plural glass substrates W are interposed between a pair of the lapping plates 11 and 12.

The grinding pad used in the second lapping step is a diamond pad 20B shown in FIGS. 2A and 2B. The diamond pad 20B has a substrate 22 having a lap surface 20a. On the lap surface 20a, there are plural protrusions 21 having a flat top in which diamond abrasive grains are fixed with a binder (bond).

In the diamond pad 20B used in the second lapping step, the outside dimension S of the protrusion 21 preferably has a size of 1.5 mm to 5 mm square, 0.2 mm to 3 mm in height T, and 0.5 mm to 3 mm in gap G between adjacent protrusions 21, similar to the diamond pad 20A used in the first lapping step. A cooling solution or a grinding fluid reaches uniformly all parts of the diamond pad 20B having such dimensions. Therefore, it is also possible to remove grinding shavings, etc. from the gap between the protrusions 21 on the lap surface 20a by using the diamond pad 20B.

In the diamond pad 20B used in the second lapping step, the average grain diameter of the diamond abrasive grains is preferably in a range of 1 μm to 5 μm. The content of the diamond abrasive grains in the protrusion 21 is preferably in a range of 5% by volume to 80% by volume, and more preferably in a range of 50% by volume to 70% by volume. When the grain diameter or the content of the diamond abrasive grains is less than the lower limit, the process time is longer, and increases the process cost. On the other hand, when the grain diameter or the content of the diamond abrasive grains is more than the upper limit, it becomes difficult to obtain a desired surface roughness. Moreover, as the binder of the diamond pad 20B, polyurethane resins, phenol resins, melamine resins or acrylic resins can be used.

In the subsequent third lapping step for the main surfaces, the main surfaces of the glass substrate W are thirdly lapped by using the lapping machine 10 shown in FIG. 1, similar to the first and second lapping step for the main surfaces. That is, the lapping machine 10 includes a pair of lapping plates 11 and 12 which are vertically arranged and rotate in the opposite direction to each other. Plural glass substrates W are arranged between the lapping plates 11 and 12. The main surfaces of the glass substrates W are grinded by the grinding pad fixed to the lapping plates 11 and 12.

The grinding pad used in the third lapping step is a diamond pad 20C shown in FIGS. 2A and 2B. The diamond pad 20C has a substrate 22 having a lap surface 20a. On the lap surface 20a, there are plural protrusions 21 having a flat top in which diamond abrasive grains are fixed with a binder (bond).

In the diamond pad 20C used in the third lapping step, the outside dimension S of the protrusion 21 preferably has a size of 1.5 mm to 5 mm square, 0.2 mm to 3 mm in height T, and 0.5 mm to 3 mm in gap G between adjacent protrusions 21. A cooling solution or a grinding fluid reaches uniformly all parts of the diamond pad 20C having such dimensions. Therefore, it is also possible to remove grinding shavings from the gap between the protrusions 21 on the lap surface 20 by using the diamond pad 20C.

In the diamond pad 20C used in the third lapping step, the average grain diameter of the diamond abrasive grains is preferably 0.2 μm or more and less than 2 μm. The content of the diamond abrasive grains in the protrusions 21 is preferably in a range of 5% by volume to 80% by volume, and more preferably in a range of 50% by volume to 70% by volume. When the grain diameter or the content of the diamond abrasive grains is less than the lower limit, the process time is longer, and increases the process cost. On the other hand, when the grain diameter or the content of the diamond abrasive grains is more than the upper limit, it becomes difficult to obtain a desired surface roughness. Moreover, as the binder of the diamond pad 20C, polyurethane resins, phenol resins, melamine resins or acrylic resins can be used.

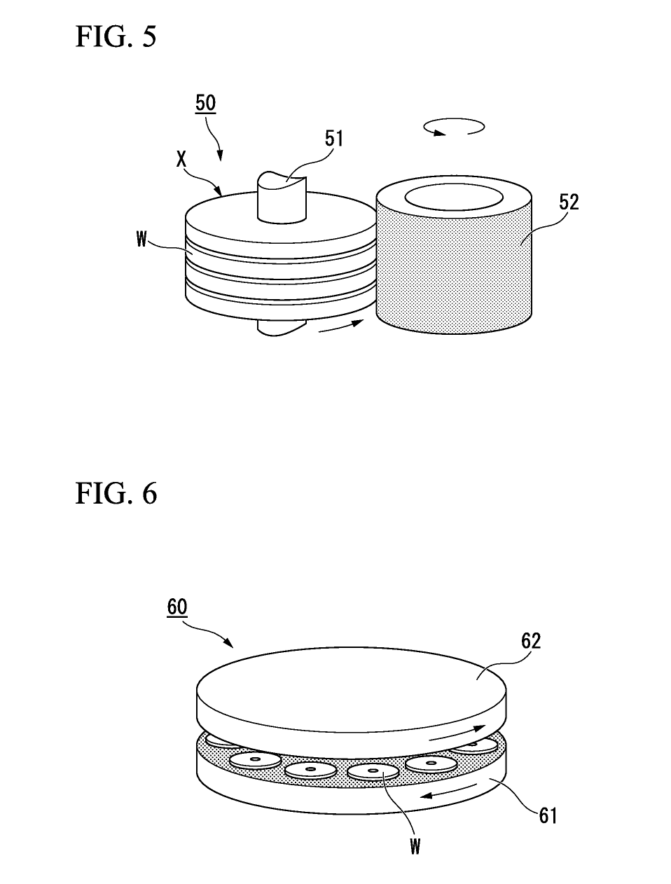

In the subsequent polishing step for the outer periphery, the outer periphery of the glass substrate W is polished using the polishing machine 50 as shown in FIG. 5. The polishing machine 50 has a rotation shaft 51 and a polishing brush 52 for the outer periphery. The rotation shaft 51 is inserted in the laminated body X, which was obtained by laminating plural glass substrates W and inserting a spacer S between the glass substrates W so as to align the center holes of the glass substrates W and the spacers S. Then, the laminated body X is rotated around the axis of the rotation shaft 51. At the same time, the polishing brush 52 for the outer periphery, which is in contact with the outer periphery of the glass substrates W, moves vertically while rotating in the opposite direction to the rotation direction of the laminated body X. During this time, a polishing liquid is dropped to the polishing brush 52 for the outer periphery. Thereby, the outer periphery of the glass substrates W is polished by the polishing brush 52 for the outer periphery. At the same time, the edge portions (chamfer) in the outer periphery of the glass substrates W, which are chamfered in the grinding step for the inner and outer peripheries, are also polished. Moreover, as the polishing liquid, a slurry, which is obtained by dispersing silicon oxide (colloidal silica) abrasive grains or cerium oxide abrasive grains in water, can be used.

Moreover, by its very nature, it is difficult to shorten the process time for the polishing step. Therefore, the polishing step needs a process time which is longer than the process time in the grinding step. On the other hand, the smoothness of the outer periphery (including the chamfers) of the glass substrate W is lower than that (Ra: 0.3 nm to 0.5 nm) of the main surfaces, specifically, the Ry of the outer periphery is less than 10 μm or less (several micrometers). Therefore, when silicon oxide (colloidal silica) abrasive grains (grain diameter: 0.3 μm or less) are used, since the silicon oxide is too fine, the process time for polishing generally tends to be longer. Due to this fact, the average grain diameter of the silicon oxide (colloidal silica) abrasive grains is preferably in a range of 0.4 μm to 1 μm, and more preferably in a range of 0.45 μm to 0.6 μm.

In addition, since the inner periphery of the glass substrate W can be etched in the present invention, the microcracks in the inner periphery can also be removed. Therefore, when the glass substrate W is polished with a cerium oxide slurry, the process time can be reduced.

In the subsequent polishing step for the main surfaces, the main surfaces of the glass substrate W are polished using the polishing machine 60 shown in FIG. 6. The polishing machine 60 has a pair of lapping plates 61 and 62 which are vertically arranged and rotate in the opposite direction to each other. Plural glass substrates W are arranged between the lapping plates 61 and 62. The main surfaces of the glass substrates W are polished by the polishing pad fixed to the lapping plates 61 and 62.

For example, a hard polishing cloth made of polyurethane can be used as the polishing pad used in this polishing step for the main surfaces. When the main surfaces of the glass substrates W are polished using this hard polishing cloth, a polishing liquid is dropped to the glass substrates W. As the polishing liquid, a slurry, which is obtained by dispersing silicon oxide (colloidal silica) abrasive grains in water, can be used.

The glass substrate W which is subjected to the lapping, grinding, and polishing steps is sent to a final cleaning step and an inspection step. For example, in the final cleaning step, the glass substrate W is cleaned by chemical cleaning using both ultrasonic wave and a cleaner (chemical agent) to remove the polishing agent etc. used in the previous steps. In the inspection step, presence or absence of defects, such as scratches and laps on the surface (the main surfaces, inner and outer peripheries, and chamfers) of the glass substrate W is examined by an optical inspection unit using a laser, for example.

In the present invention, a commercial grinding liquid can be used as the grinding liquid used in the lapping step and grinding step explained above. The grinding liquid can be classified into an aqueous grinding liquid and an oily grinding liquid. Examples of the aqueous grinding liquid include pure water, and aqueous solutions containing an appropriate amount of alcohol, aqueous solutions containing an appropriate amount of polyethylene glycol, amine, a surfactant as a viscosity regulating agent. Examples of the oily grinding liquid include oils, and oil containing an appropriate amount of stearic acid as an extreme-pressure additive. Examples of the commercial grinding liquid include aqueous Sabrelube 9016 (marketed by Chemetall) and Coolant D3 (marketed by NEOS COMPANY LIMITED).

In the present invention, a polishing auxiliary or anticorrosive may be added in the grinding liquid or the polishing liquid used in the lapping step or grinding step.

Specifically, the polishing auxiliary preferably contains an organic polymer having at least a sulfonic acid group or carboxylic acid group, and is more preferably an organic polymer having an average molecular weight of 4,000 to 10,000 and containing sodium sulfonate and sodium carboxylate. It is possible to make the surfaces (main surfaces, inner and outer peripheries, and chamfers) of the glass substrate W further smooth by using such a polishing auxiliary.

In addition, examples of the organic polymer containing sodium sulfonate or sodium carboxylate include GEROPON® SC/213 (marketed by Rhodia), GEROPON® T/36 (marketed by Rhodia), GEROPON® TA/10 (marketed by Rhodia), GEROPON® TA/72 (marketed by Rhodia), Newkalgen WG-5 (marketed by TAKEMOTO OIL & FAT Co., Ltd.), Agrisol G-200 (marketed by Kao Corporation), Demol EP powder (marketed by Kao Corporation), Demol RNL (marketed by Kao Corporation), Isoban 600-SF35 (marketed by KURARAY CO, LTD.), Polystar OM (marketed by NOF CORPORATION), SOKALAN® CP9 (marketed by BASF Japan Ltd.), SOKALAN® PA-15 (marketed by BASF Japan Ltd.), Toxanon GR-31A (marketed by Sanyo Chemical Industries, Ltd.), Sorpol 7248 (marketed by TOHO Chemical Industry Co., LTD.), Sharol AN-103P(MARKETED BY DAI-CHI KOGYO SEIYAKU CO., LTD.), Aron T-40 (marketed by TOAGOSEI CO., LTD.), Panakayaku CP (marketed by NIPPON KAYAKU Co., Ltd.), and Disroll H12C (marketed by Nippon Nyukazai Co., Ltd.). Among these, Demol RNL (marketed by Kao Corporation) or Polystar OM (marketed by NOF CORPORATION) is preferable.

The magnetic recording medium generally contains substances that can easily be eroded, such as Co, Ni, and Fe in the magnetic layer. Therefore, when the glass substrate W is processed using the grinding liquid or the polishing liquid which contains an anticorrosive, it is possible to prevent the magnetic layer from corrosion, and obtain a magnetic recording medium having excellent electromagnetic properties.

As the anticorrosive, benzotriazoles or derivatives thereof are preferably used. Examples of the derivatives of benzotriazole include benzotriazole derivatives in which at least one hydrogen atom in benzotriazole is substituted with a carboxyl group, methyl group, amino group, hydroxyl group, etc. Preferable examples of the benzotriazole derivative include 4-carboxyl benzotriazole and its salt, 7-carboxyl benzotriazole and its salt, benzotriazole butyl ester, 1-hydroxymethyl benzotriazole, and 1-hydroxybenzotriazole. The amount of the anticorrosive added in the diamond slurry is preferably 1% by mass or less, and more preferably in a range of 0.001% by mass to 0.1% by mass.

The present invention is not limited to the above embodiments, and the constitution of the present invention can be changed as long as the change of the constitution is within the scope of the present invention.

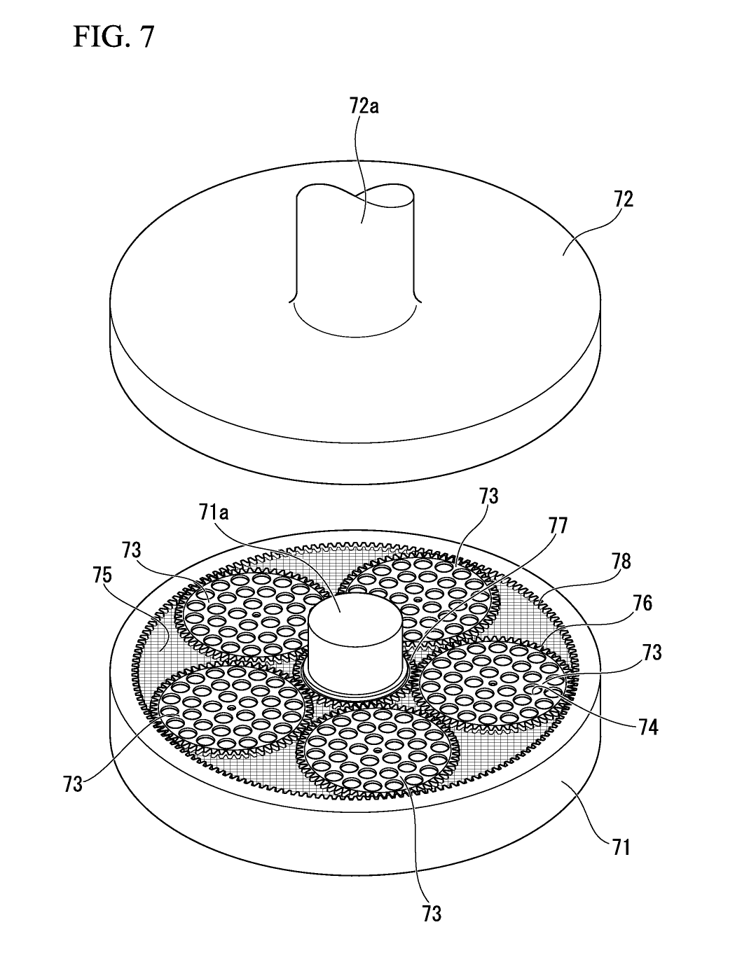

For example, the lapping machine or the polishing machine used in the embodiments can be replaced with the lapping machine or the polishing machine shown in FIG. 7. The lapping machine or the polishing machine shown in FIG. 7 includes a pair of a lower lapping plate 71 and an upper lapping plate 72. The lower lapping plate 71 has a recess 75 on the upper surface which faces the upper lapping plate 72. In the recess 75, plural carriers 73 (5 carriers in FIG. 7) are formed. In the carrier 35, plural openings 74 (35 openings in FIG. 7) are formed. The glass substrate W is set in plural openings 74 (35 openings in FIG. 7) in each carrier 73. Then, the main surfaces of the glass substrates W are grinded or polished by the grinding pad or the polishing pad fixed to the lower and upper lapping plates 71 and 72.

The lower and upper lapping plates 71 and 72 rotate in opposite directions to each other by rotating the rotation shafts 71a and 72a formed at the center of the lower and upper lapping plates 71 and 72 with a motor (not shown in figures), while the central axes 71a and 72a are coaxially arranged.

For example, the carrier 73 is a disk made of an epoxy resin which is reinforced by mixing aramid fiber or glass fiber. The carriers 73 are arranged in the recess 75 so as to surround the rotation shaft 71a. In addition, a planet gear 76 is formed at the entire outer periphery of the carriers 73. On the other hand, a sun gear 77, which rotates together with the rotation shaft 71a while engaging with the planet gear 76 of each carrier 73, is formed in the inner periphery of the recess 75. Furthermore, a fixed gear 78, which engages the planet gear 76 of the carriers 73, is formed in the outer periphery of the recess 75.

Due to this structure, when the sun gear 77 rotates together with the rotation shaft 71a, the sun gear 77, the fixed gear 78, and the planet gear 76 are engaged. Then, the carriers 73 rotate around their axes in an opposite direction to the rotation direction of the rotation shaft 71a while revolving around the rotation shaft 71a in the same rotation direction as that of the rotation shaft 71a. The carriers 73 perform so-called “sun-and-planet motion”.

Therefore, when the abovementioned lapping machine or polishing machine shown in FIG. 7 is used in the lapping step or the polishing step in the present invention, it is possible to lap or polish the main surfaces of the glass substrates W with a grinding pad fixed to the lower and upper lapping plates 71 and 72 by making the plural glass substrates W fixed in the opening 74 of the carrier 73 perform the sun-and-planet motion. When the lapping machine or the polishing machine has such a structure, it is possible to rapidly lap or polish the glass substrates W with high accuracy.

### EXAMPLES

The present invention and the effects obtained by the present invention will be explained in detail referring to the following Examples. Moreover, the present invention is not limited to the following Examples, and the constitution of the present invention can be changed as long as the change of the constitution is within the scope of the present invention.

### Example 1

In this Example 1, a glass substrate (TS-10SX, marketed by OHARA INC.) having an outer diameter of 48 mm, and a thickness of 0.560 mm, and a center hole having a diameter of 12 mm was used.

The glass substrate was subjected to the first lapping step for the main surfaces, the first grinding step for the inner and outer peripheries, the second grinding step for the inner and outer peripheries, the etching step for the inner and outer peripheries, the polishing step for the inner periphery, the second lapping step for the main surfaces, the third lapping step for the main surfaces, the polishing step for the outer periphery, and the polishing step for the main surfaces.

Specifically, in the first lapping step for the main surfaces, a lapping machine having a pair of lapping plates which are vertically arranged and rotate in opposite directions to each other was used. The main surfaces of plural glass substrates were grinded with grinding pads fixed to the lapping plates by inserting the plural glass plates between the lapping plates and rotating the lapping plates in opposite directions to each other. As the grinding pad in the first lapping step, a diamond pad (TRIZACT®, marketed by Sumitomo 3M Limited) was used. The diamond pad includes protrusions of which the outside dimension S is 2.6 mm square, the height is 2 mm, and the gap between adjacent protrusions is 1 mm. The average grain diameter of the diamond abrasive grains is 9 μm. The content of the diamond abrasive grains in the protrusions is about 20% by volume. As the binder resin, an acrylic resin is used.

The main surfaces of the glass substrate were lapped using a 4-way-type Double side polishing machine (16B type; marketed by HAMAI COL, LTD.) under conditions in which the rotation speed of the lapping plates was 25 rpm, and the process pressure was 120 g/cm² for 15 minutes. As the polishing liquid, Coolant D3 (marketed by NEOS COMPANY LIMITED), which had been diluted with water to 10 times, was used. The amount of each of the main surfaces grinded of the glass substrate was about 100 μm.

In the first grinding step for the inner and outer peripheries, a grinding machine having a grinding stone (inner grinding stone) for the inner periphery and a grinding stone (outer grinding stone) for the outer periphery was used. A laminated body, which had been obtained by laminating plural glass substrates and inserting a spacer between the glass substrates so as to align the center holes of the glass substrates and the spacers, was rotated around the axis of the inner grinding stone. At the same time, the laminated body was interposed in the radial direction between the inner grinding stone, which was inserted into the center hole of the laminated body, and the outer grinding stone, which was arranged at the outer circumference of the laminated body. Then, the inner grinding stone and the outer grinding stone were rotated in an opposite direction of the rotation direction of the laminated body. Thereby, the inner periphery of the glass substrates was grinded by the inner grinding stone. At the same time, the outer periphery of the glass substrates is also grinded by the outer grinding stone. As the inner and outer grinding stones, a metal-bonded diamond grinding stone is used which contains diamond abrasive grains having an average grain diameter of 20 μm at 80% by volume, and a nickel alloy binder. The rotation speed of the inner and outer grinding stones was adjusted to 1,200 rpm and 600 rpm, respectively. The grinding was carried out for 30 seconds. The amount of each inner and outer peripheries grinded was adjusted to about 100 μm

In the second grinding step for the inner and outer peripheries, a resin-bonded diamond grinding stone, in which diamond abrasive grains having an average grain diameter of 10 μm are contained at 70% by volume, and the diamond abrasive grains are bonded with a phenol resin binder, was used.

The inner and outer peripheries of the glass substrate were grinded at the rotation speed of the inner and outer grinding stones at 900 rpm and 600 rpm, respectively, for 20 seconds. The grinded amount of each inner and outer peripheries was adjusted to about 10 μm. Besides these matters, the second grinding step for the inner and outer peripheries was carried out using the same grinding machine in the same manner as those in the first grinding step for the inner and outer peripheries. Moreover, the center line average roughness (Ra) and the maximum height (Rmax) of the grinded surface after the second grinding step for the inner and outer peripheries was 0.18 μm, and 1.2 μm, respectively.

In the etching step for the inner and outer peripheries, an aqueous mixture containing 1.5% by mass-fluoric acid and 0.5% by mass-sulfuric acid was used as an etchant. Twenty-five glass substrates were laminated by inserting a spacer to obtain a laminated body. Only the inner and outer peripheries of the laminated body were in contact with the etchant at 30° C. for 10 min. After etching the glass substrates were cleaned with pure water.

In the polishing step for the inner and outer peripheries, a polishing machine having a polishing brush for the inner periphery was used. While dropping a polishing liquid to the polishing brush for the inner periphery, the laminated body was rotated around the axis of the polishing brush. At the same time, the polishing brush was rotated in an opposite direction to the rotation direction of the laminated body and vertically moved. Thereby, the inner periphery of the glass substrates was polished. The polishing brush used was a nylon brush. The polishing liquid was a silicon oxide slurry which had been obtained by adding water in a silica polishing liquid (average grain diameter: 0.5 μm; Compol; marketed by Fujimi Incorporated.) having a solid content of 40% by mass such that the silica content was 1% by mass. The polishing step was carried out for 10 min. by adjusting the rotation speed of the polishing brush for the inner periphery to 300 rpm.

In the second lapping step for the main surfaces, a lapping machine having a pair of lapping plates which are vertically arranged was used. Specifically, the main surfaces of the glass substrates were grinded by a grinding pad attached to the lapping plates while plural glass substrates were interposed between the lapping plates which rotated in opposite directions to each other. The grinding pad used in the second lapping step was a diamond pad (TRIZACT®, marketed by Sumitomo 3M Limited). The diamond pad includes protrusions of which the outside dimension is 2.6 mm square, the height is 2 mm, and the gap between adjacent protrusions is 1 mm. The average grain diameter of the diamond abrasive grains is 3 μm. The content of the diamond abrasive grains in the protrusions is about 50% by volume. As the binder resin, an acrylic resin is used. The main surfaces of the glass substrates were lapped using a 4-way-type Double side polishing machine (16B type; marketed by HAMAI COL, LTD.) under conditions in which the rotation speed of the lapping plates was 25 rpm, and process pressure was 120 g/cm² for 10 minutes. As the grinding liquid, Coolant D3 (marketed by NEOS COMPANY LIMITED), which had been diluted with water to 10 times, was used. The amount of each main surfaces grinded of the glass substrate was about 30 μm.

In the third lapping step for the main surfaces, a lapping machine including a pair of lapping plates, which are vertically arranged and rotate in the opposite direction to each other, was used. Plural glass substrates were arranged between the lapping plates. The main surfaces of the glass substrates were grinded by the grinding pad fixed to the lapping plates.

The grinding pad used in the third lapping step was a diamond pad (TRIZACT®, marketed by Sumitomo 3M Limited). The diamond pad includes protrusions of which the outside dimension is 2.6 mm square, the height is 2 mm, and the gap between adjacent protrusions is 1 mm. The average grain diameter of the diamond abrasive grains is 0.5 μm. The content of the diamond abrasive grains in the protrusions is about 60% by volume. As the binder resin, an acrylic resin is used. The main surfaces of the glass substrate were lapped using a 4-way-type Double side polishing machine (16B type; marketed by HAMAI COL, LTD.) under conditions in which the rotation speed of the lapping plates was 25 rpm, and process pressure was 120 g/cm² for 10 minutes. As the polishing liquid, Coolant D3 (marketed by NEOS COMPANY LIMITED), which had been diluted with water to 10 times, was used. The amount of each grinded main surface of the glass substrate was about 10 μm.

In the polishing step for the outer periphery, a polishing machine having a rotation shaft and a polishing brush for the outer periphery was used. The rotation shaft was inserted into the center hole of the laminated body which had been obtained by laminating plural glass substrates and inserting a spacer between the glass substrates so as to align the center holes of the glass substrates and the spacers. Then, the laminated body was rotated around the axis of the rotation shaft. At the same time, the polishing brush for the outer periphery was in contact with the outer periphery of the glass substrates, and was moved vertically while rotating in the opposite direction to the rotation direction of the laminated body. Thereby, the outer periphery of the glass substrates was polished by the polishing brush for the outer periphery. The polishing brush used was a nylon brush. The polishing liquid was a silicon oxide slurry which had been obtained by adding water in a silica polishing liquid (average grain diameter: 0.5 μm; Compol; marketed by Fujimi Incorporated.) having a solid content of 40% by mass such that the silica content was 1% by mass. The polishing step was carried out for 10 min by adjusting the rotation speed of the polishing brush for the outer periphery to 300 rpm.

In the polishing step for the main surfaces, a polishing machine having a pair of polishing plates, which are vertically arranged and rotate in the opposite direction to each other, was used. Plural glass substrates were arranged between the lapping plates. The main surfaces of the glass substrates were polished by the polishing pad fixed to the lapping plates while dropping a polishing liquid to the glass substrates. The polishing pad used was a suede type pad (marketed by FILWEL CO., LTD). The polishing liquid was a silicon oxide slurry which had been obtained by adding water in a silica polishing liquid (average grain diameter: 0.5 μm; Compol; marketed by Fujimi Incorporated.) having a solid content of 40% by mass such that the silica content was 0.5% by mass. The polishing machine used was a 4-way-type Double side polishing machine (16B type; marketed by HAMAI COL, LTD.). The main surfaces of the glass substrates were polished under conditions in which the rotation speed of the polishing plates was 25 rpm, and process pressure was 110 g/cm² for 30 minutes, while supplying the polishing liquid at 7 liters/min. The amount of each of the main surfaces polished of the glass substrate was about 2 μm.

Then, the obtained glass substrate was subjected to a chemical cleaning using both ultrasonic wave and an anionic surfactant and cleaning with pure water, and the glass substrate for a magnetic recording medium according to Example 1 was obtained.

### Example 2

A glass substrate for a magnetic recording medium was prepared in a manner identical to that of Example 1 of the present invention, except that the etching step for the inner and outer peripheries was not carried out.

### Example 3

A glass substrate for a magnetic recording medium was prepared in a manner identical to that of Example 1 of the present invention, except that the polishing step for the inner and outer peripheries was not carried out.

### Example 4

A glass substrate for a magnetic recording medium was prepared in a manner identical to that of Example 1 of the present invention, except that the etching step and the polishing step for the inner and outer peripheries was not carried out.

### Comparative Example 1

In this Comparative Example 1, a comparative glass substrate for a magnetic recording medium was prepared in a manner identical to that of Example 1 of the present invention, except that, in the second grinding step for the inner and outer peripheries, a metal-bonded diamond grinding stone, in which diamond abrasive grains having an average grain diameter of 10 μm are contained at 70% by volume and the diamond abrasive grains are fixed with a nickel alloy, was used as the inner and outer grinding stones, the rotation speed of the inner and outer grinding stones was adjusted to 600 rpm and 300 rpm respectively, the grinding time was adjusted to 10 sec, and the amount of each of the inner and outer peripheries of the glass substrate grinded was adjusted to 10 μm.

The obtained glass substrate has a center line average roughness (Ra) of 0.34 μm and the maximum height (Rmax) of 1.98 μm.

Then, an impact strength of the obtained glass substrates in Examples 1 to 4 and Comparative Example 1 was evaluated. In the evaluation of an impact strength, the obtained glass substrate was rotated by fixing to a spindle of a motor while repeating urgent accelerating and decelerating in a range of 0 rpm to 2,000 rpm. Then, the damage rate was examined.

The damage rate of the glass substrate in Examples 1 to 4 and Comparative Example 1 was 4%, 6%, 7%, 9%, and 19%, respectively.

1. A method for producing a glass substrate for a magnetic recording medium including at least a grinding step for inner and outer peripheries of a disc-shaped glass substrate having a center hole,
wherein the grinding step includes a first grinding step for inner and outer peripheries of the glass substrate using a metal-bonded diamond grinding stone in which diamond abrasive grains are fixed with a metal binder, and a second grinding step for the inner and outer peripheries of the glass substrate using a resin-bonded diamond grinding stone in which diamond abrasive grains are fixed with a resin binder.

2. The method for producing a glass substrate for a magnetic recording medium according to claim 1, wherein the method further includes an etching step for the inner and outer peripheries of the glass substrate.

3. The method for producing a glass substrate for a magnetic recording medium according to claim 1, wherein the etching step is carried out after the first or second grinding step.

4. The method for producing a glass substrate for a magnetic recording medium according to claim 1, wherein the method further includes a polishing step for the inner and outer peripheries of the glass substrate.

5. The method for producing a glass substrate for a magnetic recording medium according to claim 4, wherein the polishing step is carried out after the second grinding step.

6. The method for producing a glass substrate for a magnetic recording medium according to claim 4, wherein the polishing step is carried out without cerium oxide as an abrasive.

7. The method for producing a glass substrate for a magnetic recording medium according to claim 1, wherein an average grain diameter of the diamond abrasive grains in the metal bonded diamond grinding stone is in a range from 10 μm to 60 μm, and an average grain diameter of the diamond abrasive grains in the resin-bonded diamond grinding stone is in a range from 2 μm to 20 μm.

8 The method for producing a glass substrate for a magnetic recording medium according to claim 1, wherein the binder in the metal bonded diamond grinding stone is nickel or a nickel alloy, and the binder in the resin-bonded diamond grinding stone is a phenol resin.
